(19) United States
(12) Patent Application Publication
(10) Pub. No.: US 2008/0168094 A1
(43) Pub. Date: Jul. 10, 2008

(54) Data Relay Device, Digital Content Reproduction Device, Data Relay Method, Digital Content Reproduction Method, Program, And Computer-Readable Recording Medium

(75) Inventor: Naoto Itoh, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/816,354

(22) PCT Filed: Feb. 16, 2006
(86) PCT No.: PCT/JP2006/302736

§ 371 Date: Sep. 13, 2007

(30) Foreign Application Priority Data
Feb. 16, 2005 (JP) 2005-039809

(51) Int. Cl. G06F 17/00

(52) U.S. Cl. 707/104.1; 707/E17.009

(57) ABSTRACT

In a data relay device, an acquiring unit acquires, through a network, metadata concerning the playing of a digital content by a digital-content playing device, and a converting unit converts a description format of the acquired metadata into a description format that enables playing of the digital content by the digital-content playing device. Further, a communicating unit outputs the converted metadata to the digital-content playing device to enable a play-order sharing function based on metadata transmitted through the network.

### TECHNICAL FIELD

The present invention relates to a data relay device, a digital content playing device, a data relay method, a digital content playing method, a program, and a computer-readable recording medium. However, application of the present invention is not limited to the data relay device, the digital-content playing device, the data relay method, the digital-content playing method, the program, and the computer-readable recording medium.

### BACKGROUND ART

In recent years, there have been increasing opportunities to record television programs that are digitally broadcasted or to record and play digital contents that are obtained from streaming using the Internet. To such digital contents, metadata that defines a play order and the like is attached. By rewriting this metadata, it is possible to edit the play order or the like of digital content.

If a digital-content playing device that plays digital contents according to metadata in the same description format as the description format of the rewritten metadata is used, playing a digital content in accordance with the rewritten metadata is possible with a different digital-content playing device from the digital-content playing device that has actually performed the rewriting of the metadata. A function in which rewritten metadata is shared between different digital-content playing devices and a digital content is played in accordance with the rewritten metadata is hereafter explained as a play-order sharing function (for example, Patent Documents 1 and 2 below).

Patent Document 1: Japanese Patent Laid-Open Publication No. 2002-358216

Patent Document 2: Japanese Patent Laid-Open Publication No. 2002-338412

### DISCLOSURE OF INVENTION

### Problem to be Solved by the Invention

However, for metadata that has been converted, playing devices that play digital contents according to metadata that has a different description format, previous models of devices that do not have a play-order sharing function, and devices that do not have a receiving function to receive external metadata cannot play digital contents according to rewritten metadata. Further, the play-order sharing function cannot be utilized for digital contents that do not permit use of rewritten metadata.

### Means for Solving Problem

A data relay device according to claim 1 of the present invention includes an acquiring unit that acquires, through a network, metadata concerning playing of a digital content by a digital-content playing device; a converting unit that converts a description format of the metadata acquired by the acquiring unit into a description format that enables playing of the digital content by the digital-content playing device; and a communicating unit that outputs, to the digital-content playing device, the metadata converted by the converting unit.

A digital-content playing device according to claim 6 of the present invention includes a first acquiring unit that acquires, through a network, metadata concerning playing of a digital content; a second acquiring unit that acquires metadata that is output from a data relay device that acquires the metadata from the network through a route different from that of the first acquiring unit, and that is converted into a description format that enables playing of the digital content by the digital-content playing device; and a playing unit that plays the digital content in accordance with the metadata that is acquired by the first acquiring unit or the second acquiring unit.

A data relay method according to claim 8 of the present invention includes an acquiring step of acquiring, through a network, metadata concerning playing of a digital content by a digital-content playing device; a converting step of converting a description format of the metadata acquired at the acquiring step into a description format that enables playing of the digital content by the digital-content playing device; and an output step of outputting, to the digital-content playing device, the metadata converted at the converting step.

A digital-content playing method according to claim 9 of the present invention includes a first acquiring step of acquiring, through a network, metadata concerning playing of a digital content; a second acquiring step of acquiring metadata that is output from a data relay device that acquires the metadata from the network through a route different from that at the first acquiring step, and that is converted into a description format that enables playing of the digital content by the digital-content playing device; and a playing step of playing the digital content in accordance with the metadata that is acquired at the first acquiring step or the second acquiring step.

A computer program according to claim 10 of the present invention causes a computer to execute the method according to claim 8 or 9.

A computer-readable recording medium according claim 11 of the present invention stores therein the computer program according to claim 10.

### BRIEF DESCRIPTION OF DRAWINGS

FIG. 1 is a block diagram illustrating one example of a functional configuration of a data relay device according to a first embodiment of the present invention;

FIG. 2 is a flowchart illustrating one example of a procedure of the processing performed by the data relay device according to the first embodiment of the present invention;

FIG. 3 is a block diagram illustrating one example of a functional configuration of a digital-content playing device according to a second embodiment of the present invention;

FIG. 4 is a flowchart illustrating one example of the procedure of the processing performed by the digital-content playing device according to the second embodiment of the present invention;

FIG. 5 is a block diagram illustrating one example of the hardware configuration of the recording/playing device according to the first example of the present invention;

FIG. 6 is a block diagram illustrating one example of the hardware configuration of the remote according to the first example of the present invention;

FIG. 7 is a block diagram illustrating one example of a network environment assuming use of the recording/playing device and the remote according to the first example of the present invention;

FIG. 8 is an explanatory diagram illustrating a play list of an original digital content;

FIG. 9 is an explanatory diagram illustrating a newly created play list;

FIG. 10 is an explanatory diagram illustrating a sequence in interactive communication that is carried out between the recording/playing device and the remote;

FIG. 11 is a block diagram of the hardware configuration of the mobile telephone according to the second example of the present invention;

FIG. 12 is a block diagram illustrating one example of a network environment assuming use of a recording/playing device and a mobile telephone according to another example of the present invention; and

FIG. 13 is a block diagram illustrating a network environment assuming use of a recording/playing device and a remote according to a third example of the present invention.

### EXPLANATIONS OF LETTERS OR NUMERALS

101 Acquiring unit
102 Converting unit
103 Communicating unit
104 Determining unit
301 First acquiring unit
302 Second acquiring unit
303 Playing unit
304 Determining unit

### BEST MODE(S) FOR CARRYING OUT THE INVENTION

Exemplary embodiments of a data relay device, a digital-content playing device, a data relay method, a digital-content playing method, a program, and a computer-readable recording medium according to the present invention are explained in detail below with reference to the accompanying drawings.

### FIRST EMBODIMENT

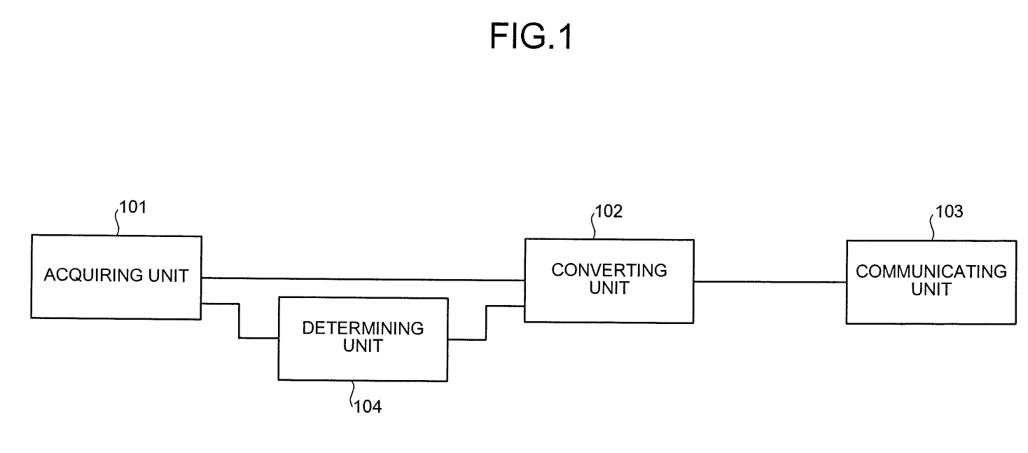

FIG. 1 is a block diagram illustrating one example of a functional configuration of a data relay device according to a first embodiment of the present invention. This data relay device according to the first embodiment of the present invention can be implemented by, for example, a remote control (hereinafter, “remote”) that is provided separately from the digital-content playing device. As shown in FIG. 1, the data relay device according to the first embodiment includes an acquiring unit 101, a converting unit 102, a communicating unit 103, and a determining unit 104.

The acquiring unit 101 acquires metadata concerning playing of a digital content. The metadata is a program that can be executed by the digital-content playing device to play the digital content by a digital-content playing device that is associated therewith in advance. The metadata is described according to a description format such as XML (extensible markup language). Specifically, the metadata defines a playing condition, a recording condition, and the like of a digital content. For example, the playing condition includes a play order and an audiovisual condition.

A technique to associate the data relay device and the digital-content playing device is widely known in an operation technology of an electronic device using a mobile terminal device known as a general purpose remote. The general purpose remote is a remote control unit that is provided so as to be compatible with a variety of electronic devices not only with one kind of electronic device, so that a variety of devices can be controlled. The general purpose remote includes operation keys by which operation instructions of a user are received, and is capable of controlling the playing operation of a digital-content playing device according to key manipulation.

As one example of a technique to associate the data relay device and the digital-content playing device, a list of commands to be output from the data relay device to the digital-content playing device are described in a plurality of description formats and provided in the data relay device in advance.

When the data relay device and the digital-content playing device are associated, to the digital-content playing device that is desired to be associated with the data relay device, commands to request a response are sequentially output while changing the description formats. The operation to output the commands to request a response can be performed by user operation.

The digital-content playing device outputs a response signal to the data relay device when a command that is described in a respond-able description format. Thus, the data relay device and the digital-content playing device can be associated. The technique of associating a data relay device and a digital-content playing device is a conventional technology, and therefore, the explanation thereof is omitted.

The converting unit 102 converts the description format of the metadata that is acquired by the acquiring unit 101 into a description format that enables playing of the digital content by the digital-content playing device. The converting unit 102 can be configured to convert the description format of the metadata acquired by the acquiring unit 101 when the determining unit 104 determines that it is not the description format enabling the playing of the digital content by the digital-content playing device.

The communicating unit 103 outputs the metadata converted by the converting unit 102 to the digital-content playing device. The communicating unit 103 can be configured to include an interface that corresponds to an interface provided in the digital-content playing device, and to output the metadata through the interface. The interface includes, for example, an infrared ray communication I/F that performs communication by infrared rays.

The determining unit 104 determines whether the description format of the metadata that is acquired by the acquiring unit 101 is a description format that enables playing of the digital content by the digital-content playing device.

### (Procedure of Processing by Data Relay Device)

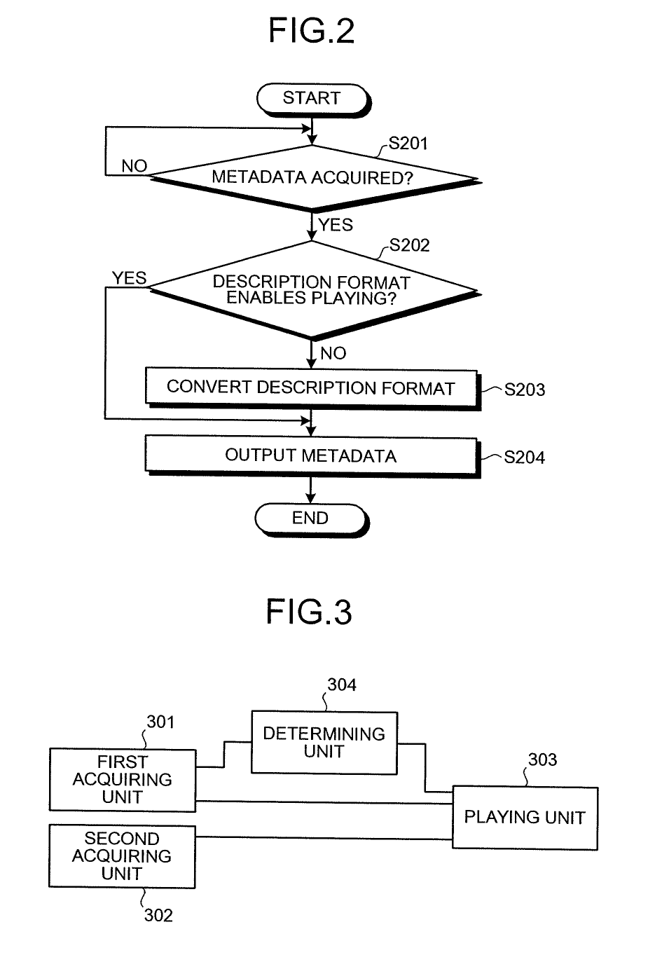

Next, a procedure of a processing performed by the data relay device according to the first embodiment of the present invention is explained. FIG. 2 is a flowchart illustrating one example of a procedure of the processing performed by the data relay device according to the first embodiment of the present invention. The processing shown in FIG. 2 is performed on the condition that a digital content to be played is present in the digital-content playing device that is associated in advance.

The state that a digital content to be played is present in the digital-content playing device can be a state in which the digital content is stored in a storage unit provided in the digital-content playing device, or can be a state in which a recording medium on which the digital content is recorded can be read by the digital-content playing device.

The digital content can be obtained by recording a television program that is digitally broadcasted or can be obtained through streaming using the Internet. The digital content can be created, for example, by editing a home video picture that is shot using a plurality of cameras.

In the processing shown in FIG. 2, first, involves waiting until it is determined that metadata concerning playing of a digital content by the digital-content playing device is acquired through a network (step S201: NO). The metadata is transmitted with a digital content of, for example, a broadcast program. There is a case where the metadata is transmitted at an arbitrary timing irrespective to broadcast timing of the program.

When it is determined that the metadata is acquired through the network (step S201: YES), it is determined whether a description format of the acquired metadata is a description format that enables playing of the digital content by the digital-content playing device (step S202). In the first embodiment, a determining step is achieved by a process at step S202. Moreover, in the first embodiment, an acquiring step is achieved by a process of YES at step S201.

At step S202, specifically, it is determined, for example, whether a language that describes the metadata is a program language that works in the digital-content playing device. When it is determined that the description format of the acquired metadata is the description format that enables playing of the digital content by the digital-content playing device (step S202: YES), the process proceeds to step S204.

On the other hand, when it is determined that the description format of the acquired metadata is not the description format that enables playing of the digital content by the digital-content playing device (step S202: NO), the description format of the acquired metadata is converted into the description format that enables playing of the digital content by the digital-content playing device (step S203). In the first embodiment, a converting step is achieved by a process at step S203.

The converted metadata is then output to the digital-content playing device (step S204). In the first embodiment, a communicating step is achieved by a process at step S204.

The data relay device according to the present invention is not limited implementation by a remote. For example, a mobile terminal device that is provided separately from the digital-content playing device can be employed. The mobile terminal device includes, for example, a mobile telephone, a PDA (personal digital assistance), and the like.

As described, according to the first embodiment, a description format of metadata that is acquired through a network is converted in to a description format that enables playing of a digital content by the digital-content playing device, and the converted metadata is output to the digital-content playing device. Thus, the digital content can be played in accordance with the acquired metadata by the digital-content playing device independent of the description format of the metadata acquired through the network, in other words, the play-order sharing function can be used.

Through the acquisition of the metadata with the data relay device, the play-order sharing function can be used even in the digital-content playing device that is not connected (cannot be connected) to a network.

According to the first embodiment, when the description format of the acquired metadata is not the description format that enables playing of the digital content by the digital-content playing device, the description format of the acquired metadata is converted. This enables use of the play-order sharing function in the digital-content playing device without excessive processing.

Since the metadata is output through an interface that corresponds to an interface provided in the digital-content playing device, it is possible to cause the digital-content playing device to surely acquire the metadata that is output from the data relay device.

Furthermore, by employing a remote that is separately provided from the digital-content playing device as the data relay device, the data relay device can be associated with the digital-content playing device at an arbitrary timing. Similarly, by employing a mobile terminal device that is provided separately from the digital-content playing device as the data relay device, the data relay device can be associated with the digital-content playing device at an arbitrary timing.

By this arrangement, even in a digital-content playing device that had not been able to use the play-order sharing function before the association, it becomes possible to use the play-order sharing function after the association. The data relay device is not limited to one provided separately from the digital-content playing device. The data relay device can be provided integrally with the digital-content playing device.

### SECOND EMBODIMENT

FIG. 3 is a block diagram illustrating one example of a functional configuration of a digital-content playing device according to a second embodiment of the present invention. The digital-content playing device according to the second embodiment of the present invention can be implemented by a recording/playing device that is provided so as to be able to communicate with, for example, a remote that is provided separately from the digital-content playing device. As shown in FIG. 3, the digital-content playing device according to the second embodiment includes a first acquiring unit 301, a second acquiring unit 302, a playing unit 303, and a determining unit 304.

The first acquiring unit 301 acquires, through a network, metadata concerning playing of a digital content. The second acquiring unit 302 acquires metadata that is output from the data relay device that acquires metadata from the network through a different route from that of the first acquiring unit 301, and that is converted into a description format that enables playing of the digital content by the digital-content playing device. In other words, although both of the first acquiring unit 301 and the second acquiring unit 302 acquire metadata, the first acquiring unit 301 and the second acquiring unit 302 acquire metadata through different routes.

The playing unit 303 plays the digital content in accordance with the metadata acquired by the first acquiring unit 301 or the second acquiring unit 302. When the determining unit 304 determines that the metadata is not a description format that enables playing of the digital content, the playing unit 303 can be configured to play the digital content in accordance with the metadata that is acquired by the second acquiring unit 302. The determining unit 304 determines whether the description format of the metadata that is acquired by the first acquiring unit 301 is a description format that enables playing of the digital content.

### (Procedure of Processing by Digital-Content Playing Device)

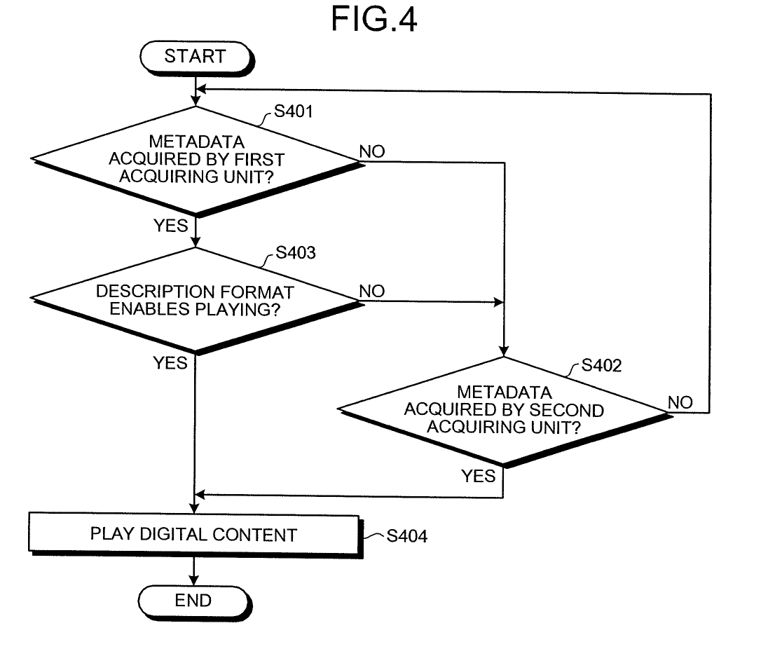

Next, a procedure of a processing performed by the digital-content playing device according to the second embodiment of the present invention is explained. FIG. 4 is a flowchart illustrating one example of the procedure of the processing performed by the digital-content playing device according to the second embodiment of the present invention. In the processing shown in FIG. 4, first, it is determined whether the first acquiring unit 301 has acquired metadata (step S401).

When it is determined that the first acquiring unit 301 has not acquired metadata (step S401: NO), it is determined whether the second acquiring unit 302 has acquired metadata (step S402). When it is determined that the second acquiring unit 302 has not acquired metadata (step S402: NO), the process proceeds to step S401.

When it is determined that the first acquiring unit 301 has acquired metadata (step S401: YES), it is determined whether a description format of the acquired metadata is a description format that enables playing of a digital content (step S403). In the second embodiment, a determining step is achieved by a process at step S403. Moreover, in the second embodiment, a first acquiring step is achieved by a process of YES at step S401.

When it is determined that the description format of the acquired metadata is the description format that enables playing of the digital content (step S403: YES), the digital content is played in accordance with the acquired metadata (step S404). In the second embodiment, a playing step is achieved by a process at step S404. When it is determined that the description format of the acquired metadata is not the description format that enables playing of the digital content (step S403: NO), the process proceeds to step S402.

When it is determined that the second acquiring unit 302 has acquired metadata (step S402: YES), the process proceeds to step S404. In the second embodiment, a second acquiring step is achieved by a process of YES at step S402.

As described, according to the second embodiment, the digital content is played in accordance with metadata that is acquired through a network by the first acquiring unit 301 or with metadata that is acquired from the network through a different route from that of the first acquiring unit 301. With this arrangement, even when one of the first acquiring unit 301 and the second acquiring unit 302 cannot acquire metadata for some reason, by acquiring the metadata by the other one of the first acquiring unit 301 and the second acquiring unit 302, the playing of digital data in accordance with the metadata can be performed more reliably.

The metadata that is acquired by the second acquiring unit 302 is output from the data relay device, and is converted into a description format that enables playing of a digital content by the data relay device. With this arrangement, even when playing can not be performed in accordance with the metadata that is acquired by the first acquiring unit 301, the digital content can be played in accordance with the metadata that is acquired by the second acquiring unit 302.

Moreover, when the description format of the metadata that is acquired by the first acquiring unit 301 is not a description format that enables playing of a digital content, the digital content is played in accordance with the metadata that is acquired by the second acquiring unit 302. By this arrangement, the digital content can be played in accordance with metadata on which unnecessary conversion is not performed, and therefore, more reliable playing can be achieved.

### FIRST EXAMPLE

Next, hardware configurations of a recording/playing device and a remote according to a first example of the present invention are explained. In the first example, the digital-content playing device according to the present invention is implemented by the recording/playing device, and the data relay device according to the present invention is implemented by the remote.

### (Hardware Configuration of Recording/Playing Device)

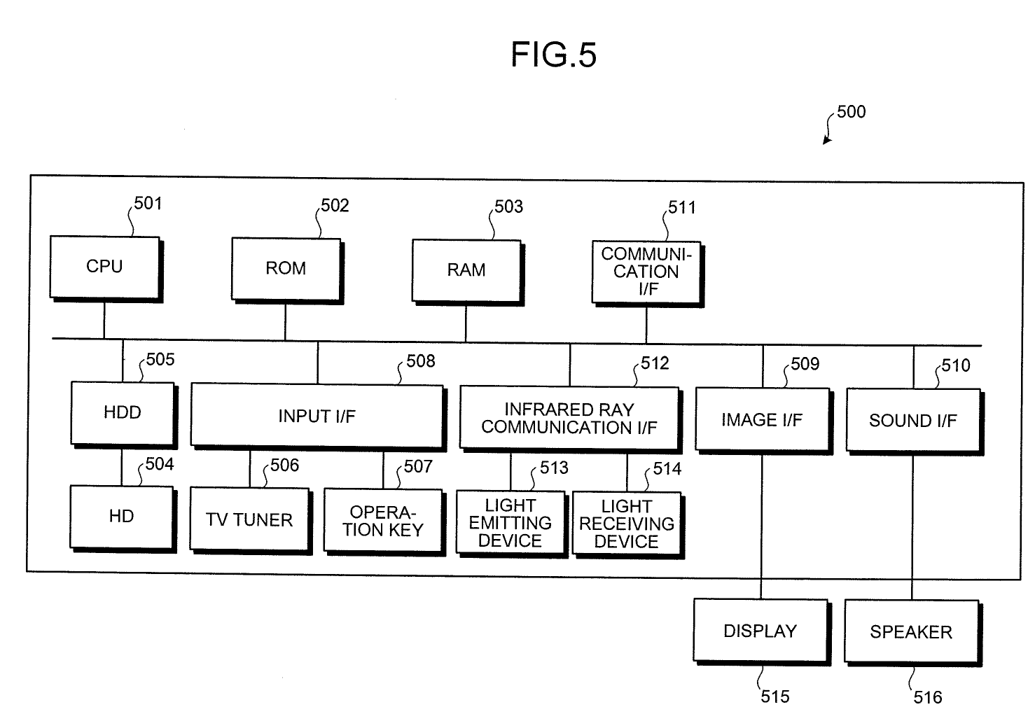

First, the recording/playing device is explained. FIG. 5 is a block diagram illustrating one example of the hardware configuration of the recording/playing device according to the first example of the present invention. A recording/playing device 500 includes a CPU 501, a ROM 502, a RAM 503, an HD 504, an HDD 505, a TV tuner 506, an operation key 507, an input I/F 508, an image I/F 509, a sound I/F 510, a communication I/F 511, an infrared ray communication I/F 512, a light emitting device 513, and a light receiving device 514.

The CPU (central processing unit) 501 controls driving of each component provided in the recording/playing device 500. The CPU 501 performs various kinds of arithmetic processing according to a control program that is stored in the ROM 502 and the like, thereby controlling driving of each component in the recording/playing device 500. The CPU 501 performs a command processing corresponding to an input based on a signal output from the operation key 507.

The CPU 501 determines whether a description format of metadata that is acquired through the communication I/F 511 is a description format that enables playing of a digital content. In the first example, the determining unit 304 of the second embodiment described above is implemented by the CPU 501.

The CPU 501 controls operations of each component that is involved in the playing of the digital content so that the playing of the digital content is performed in accordance with metadata that is acquired by the infrared ray communication I/F 512 when a description format of metadata that is acquired through the communication I/F 511 is not a description format that enables playing of the digital content.

The ROM (read only memory) 502 stores fixed data such as a control program. The data stored in the ROM 502 can be rewritten by a user, but is not erased by turning off the power.

The RAM (random access memory) 503 rewritably stores variable data, and functions as a work area of the CPU 501. The RAM 503 can be a volatile memory from which stored data is erased by turning off the power, or can be a nonvolatile memory that is backed up by a battery independent of turning on/off of the power or the like.

The HD (hard disk) 504 records digital content. The digital content includes, specifically, digital content obtained by recording a program that is broadcasted on TV, and digital content that is downloaded through the communication I/F 511. The digital content can be, for example, an animation that has play order, not a single still image. A recording medium on which a digital content is recorded is not limited to the HD 504. As a recording medium that records a digital content, instead of the HD 504 or in addition to the HD 504, for example, a DVD can be used.

The HDD (hard disk drive) 505 performs writing/reading of digital content with respect to the HD 504. When digital content is recorded on a DVD instead of the HD 504 or in addition to the HD 504, a DVD drive is used instead of the HDD 505 or in addition to the HDD 505.

The TV tuner 506 tunes a wavelength of a radio wave (television wave) that includes an electrical signal of a television program that is modulated at a television broadcast station and is transmitted with a carrier wave having a high frequency, e.g., a wavelength of a television program that is digitally broadcasted. Although not recorded in high resolution quality, a digital terrestrial broadcast can be recorded also by a conventional VHS or DVD recorder by inputting an output from the TV tuner 506. The TV tuner 506 outputs the tuned electrical signal of the television program to the input I/F 508.

The operation key 507 receives data input by a user. Through operation of the operation key 507, characters, numerals, various instructions, and the like can be input. For the operation key 507, various conventional forms such as a push button switch that detects physical pushing/not pushing, a touch panel, a push key, and a joy stick can be employed. The operation key 507 outputs, to the input I/F 508, information that is input by the user. The input I/F 508 outputs, to the CPU 501, a signal that is output from the TV tuner 506 and the operation key 507.

The image I/F 509 controls driving of a display 515 that is connected to the image I/F 509, and causes the display 515 to display an image based on the digital content. Specifically, the image I/F 509 is configured with a graphic controller that controls the entire display 515, a buffer memory such as a VRAM (video RAM) that temporarily stores image data that can be instantly displayed, a control IC that controls a display operation of the display 515 based on the image data that is output from the graphic controller, and the like. As the display 515, various conventional displays, specifically, for example, a CRT (cathode ray tube), a TFT liquid crystal display, an organic EL display, a plasma display, and the like, can be used.

The sound I/F 510 can be configured with, for example, a D/A converter that generates an analog sound signal by performing D/A conversion on a digital sound signal, and a an A/D converter that performs A/D conversion on an analog sound signal. To the sound I/F 510, a speaker 516 that amplifies the analog signal output from the D/A converter is connected.

At the playing of a digital content, a digital content recorded, for example, on the HD 504 is read by the HDD 505. An image based on the read digital content is displayed on the display 515 through the image I/F 509. Furthermore, a sound based on the read digital content is output to the speaker 516 through the sound I/F 510. At the playing of the digital content, operations of the HD 504, the HDD 505, the image I/F 509, and the sound I/F 510 are controlled by the CPU 501. In the first example, the playing unit 303 of the second embodiment described above is implemented by the CPU 501, the HD 504, the HDD 505, the image I/F 509, and the sound I/F 510.

The communication I/F 511 communicates with an external device through various kinds of communication networks such as a public line (telephone line, ISDN line, ADSL line, etc.). Specifically, the communication I/F 511 is configured with a line connecting device and a communication control device. The communication I/F 511 acquires metadata that is output from, for example, an external device through a network. In the first example, the first acquiring unit 301 of the second embodiment described above is implemented by the communication I/F 511.

To the communication network, besides the recoding/playing device 500, various kinds of servers and personal computers, a small-scale network such as LAN, and the like are connected. Although explanation is omitted since it is a conventional technology, the communication network constitutes a part of the Internet. Therefore, the recording/playing device 500 is connected to the Internet through the communication I/F 511. The communication I/F 511 performs communication using a protocol such as TCP/IP, for example.

To the infrared ray communication I/F 512, the light emitting device 513 that emits an infrared ray, and the light receiving device 514 that receives an infrared ray are connected. The infrared ray communication I/F 512 controls lighting on/off of the light emitting device 513, and converts an optical signal that is received by the light receiving device 514 into an electrical signal.

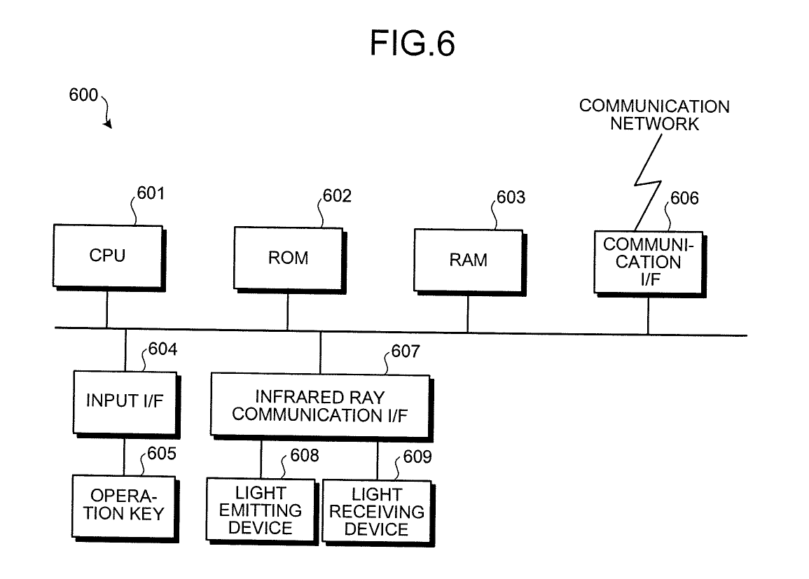

The infrared ray communication I/F 512 outputs the electrical signal obtained as a result of photoelectric conversion to the CPU 501. The infrared ray communication I/F 512 acquires metadata that is output from a remote (see FIG. 6) that is associated therewith in advance. In the first example, the second acquiring unit 302 of the second embodiment described above is implemented by the infrared ray communication I/F 512 and the light receiving device 514.

A communication method of the infrared ray communication performed by the infrared ray communication I/F 512 includes, for example, an IrDA (IrDA1.0, IrDA1.1), an ASK/DASK, and the like. Other than these, the infrared communication can be performed using Super I/O that is applied to the infrared ray communication using a personal computer.

### (Hardware Configuration of Remote)

FIG. 6 is a block diagram illustrating one example of the hardware configuration of the remote according to the first example of the present invention. A remote 600 includes a CPU 601, a ROM 602, a RAM 603, an input I/F 604, an operation key 605, a communication I/F 606, an infrared ray communication I/F 607, a light emitting device 608, and a light receiving device 609.

The CPU 601 controls driving of each component provided in the remote 600. The CPU 601 performs various kinds of arithmetic processing according to a control program store in the ROM 602 or the like, thereby controlling driving of each component. The CPU 601 performs a command processing corresponding to an input based on a signal output from the operation key 605 through the input I/F 604.

The CPU 601 determines whether a description format of metadata that is acquired through the communication I/F 606 is a description format that enables playing of a digital content by the recording/playing device 500. In the first example, the determining unit 104 of the first embodiment described above is implemented by the CPU 601.

The CPU 601 converts the description format of the metadata that is acquired through the communication I/F 606 into a description format that enables playing of the digital content by the recording/playing device 500. In the first example, the converting unit 102 of the second embodiment described above is implemented by the CPU 601. The CPU 601 converts the description format of the metadata that is acquired through the communication I/F 606 into a description format that enables playing of the digital content by the recording/playing device 500 when the description format of the metadata acquired through the communication I/F 606 is not a description format that enables playing of the digital content by the recording/playing device 500.

The ROM 602 stores fixed data such as a control program. The data stored in the ROM 602 can be rewritten by an operation of a user, but is not erased by turning off the power. In the ROM 602, for example, a program to convert a description format of the metadata that is acquired through a network into a description format that can be command processed in the recording/playing device is stored.

The RAM 603 rewritably stores variable data, and functions as a work area of the CPU 601. The RAM 603 can be a volatile memory from which stored data is erased by turning off the power, or can be a nonvolatile memory that is backed up by a battery independent of turning on/off of the power or the like.

The communication I/F 606 communicates with an external device through various kinds of communication networks such as a public line (telephone line, ISDN line, ADSL line, etc.). Specifically, the communication I/F 606 is configured with a line connecting device and a communication control device. The communication I/F 606 acquires metadata that is output from, for example, an external device through a network. In the first example, the acquiring unit 101 of the first embodiment described above is implemented by the communication I/F 606.

To the infrared ray communication I/F 607, the light emitting device 608 that emits an infrared ray, and the light receiving device 609 that receives an infrared ray are connected. The infrared ray communication I/F 607 controls lighting on/off of the light emitting device 608 based on a control signal from the CPU 601, and converts an optical signal that is received by the light receiving device 609 into an electrical signal. The communication method of the infrared ray communication performed by the infrared ray communication I/F 607 is a communication method corresponding to the recording/playing device 500 described above.

The infrared ray communication I/F 607 outputs the electrical signal obtained as a result of photoelectric conversion to the CPU 601. The infrared ray communication I/F 607 outputs metadata that is acquired through the infrared ray communication I/F 607 to the recording/playing device 500 (see FIG. 5) that is associated therewith in advance. In the first example, the communicating unit 103 of the first embodiment described above is implemented by the infrared ray communication I/F 607 and the light emitting device 608.

The input I/F 604, the operation key 605, the infrared ray communication I/F 607, the light emitting device 608, and the light receiving device 609 are the same as those in the recording/playing device 500, and therefore, the explanation thereof is omitted.

### (Network Environment Assuming Use of Recording/Playing Device and Remote)

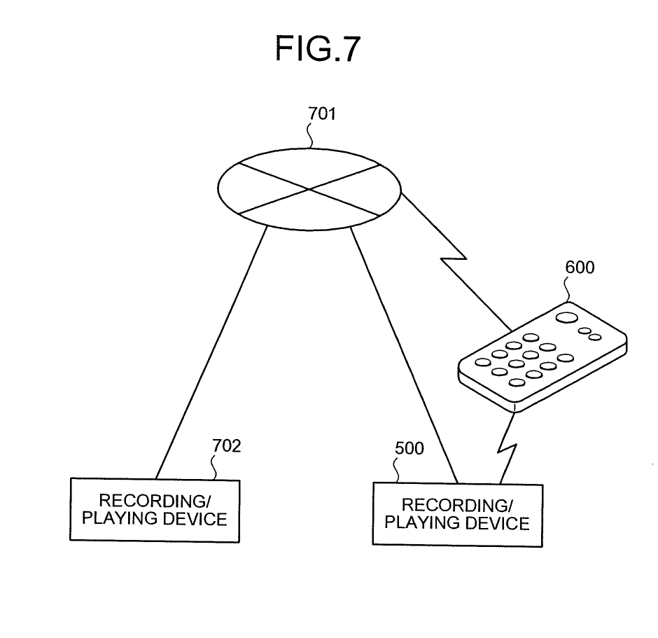

FIG. 7 is a block diagram illustrating one example of a network environment assuming use of the recording/playing device 500 and the remote 600 according to the first example of the present invention. The recording/playing device 500 and the remote 600 according to the first example are provided so as to be able to communicate with another recording/playing device 702 through a network 701 such as the Internet. Since the recording/playing device 702 has the same configuration as the recording/playing device 500 shown in FIG. 5, detailed illustration and explanation are omitted.

In the recording/playing device 702, metadata concerning a digital content can be edited. Editing of metadata by the recording/playing device 702 is explained hereafter. The metadata is, for example, data concerning the playing of a digital content such as a play order of the digital content. The metadata is formatted, for example, in an XML format, and is a program that can be executed by the recording/playing device 500 (and the recording/playing device 702).

Although explanation is omitted since it is a conventional technology, the XML is a markup language that can describe a document structure in a simple format as HTML, and that can originally define tags. The markup language is such a language that various attribute information (character types (italic, bold, etc.), form information, and hyperlink information) other than a character code of a character string and the like is described in a document as commands defined in advance. By using the XML, for example, higher functional page description than that of the HTML can be achieved on the Internet.

The metadata sets various conditions (hereinafter, “audiovisual condition”) for the playing of a digital content. The audiovisual conditions include, for example, a play order, brightness, color, sound/subtitles/telop selection information, a two screen setting, an interactive setting, copyright management, charge management, a rating, recommendation, category classification, evaluation, and the like. The play order is data that is converted from a play list.

The metadata includes data to identify a digital content to be played. At the playing of a digital content, the recording/playing device 500 plays in accordance with metadata that identifies the digital content as a play subject.

The metadata is transmitted with a digital content of, for example, a broadcast program. At the recording of a broadcast program, the recording/playing device 500 acquires metadata simultaneously with the digital content of the broadcast program. The recording/playing device 500 can play a digital content as a subject in a play order according to the metadata, based on the metadata that is acquired simultaneously with the digital content.

The metadata can be transmitted independently through the network 701 irrespective of the broadcast time of a program, specifically, such as when the metadata of a digital content obtained by the recording a broadcast program is changed at an arbitrary time and transmitted. In this case, the metadata is acquired by the communication I/F 511 or the communication I/F 606.

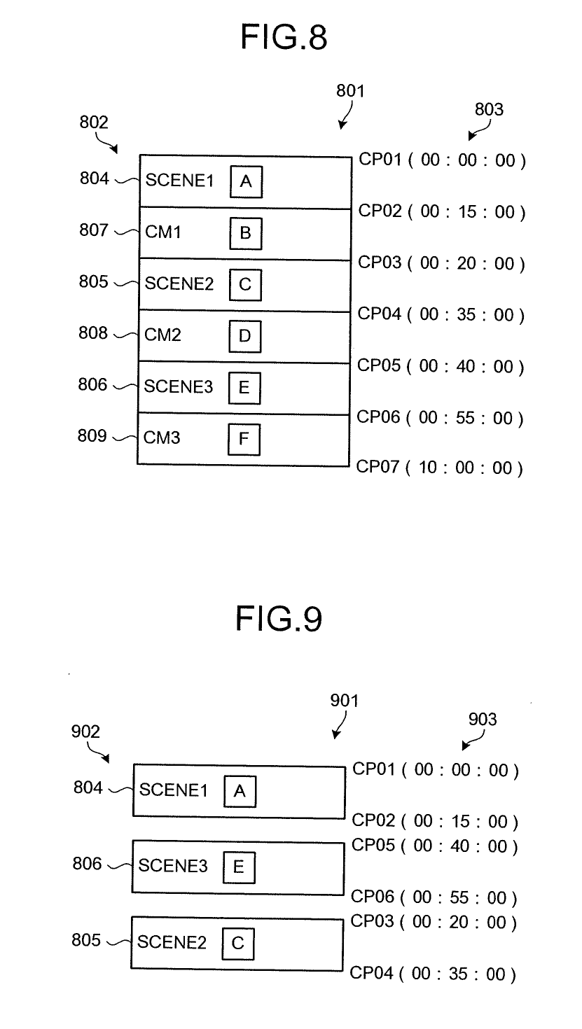

FIG. 8 is an explanatory diagram illustrating a play list of an original digital content. A play list 801 is constituted of an original content 802, and a chapter data 803. The original content 802 includes a plurality of pieces of scene data 804 to 806 and commercial (CM) data 807 to 809 that are put between the respective scene data 804 to 806.

The chapter data 803 shown in FIG. 8 defines a play start time and a play end time of each of the scene data 804 to 806 and each of the commercial data 807 to 809. In FIG. 8, for easy understanding, each of the scene data 804 to 806 and the commercial data 807 to 809 are shown with identification numbers 1 to 3 and identification character A to F assigned thereto. In the specification, the identification numbers 1 to 3 and the identification characters A to F are omitted.

The play list 801 can be newly created (changed) using, for example, a remote that is compatible with the recording/playing device 702 and a GUI (graphical user interface) using a display. Creation of the play list is a conventional technology, and therefore, the explanation thereof is omitted.

FIG. 9 is an explanatory diagram illustrating a newly created play list. According to a newly created (changed) play list 901, it can be understood that editing has been performed so that playing is performed cutting the commercial data 807 to 809 in the original content 802. Moreover, according to the newly created (changed) play list 901, it can be understood that a play order of the scene data 805 and the scene data 806 in the original content 802 is switched. In the newly created (changed) play list 901, chapter data 903 is also newly created (changed).

When the newly created (changed) play list 901 is created with respect to the play list 801, the metadata is rewritten so that the digital content is played in accordance with the newly created (changed) play list 901. The metadata is data in which a play list command is converted into a predetermined format so that the digital content is played in accordance with the newly created (changed) play list 901. While the play list 901 is just a list, the metadata is a program that is converted into the XML format or the like and that can be executed by the recorder. In the first example, the “play list” and the “metadata” are explained distinguishing each from each other.

An operation of the recording/playing device 500 is performed when the metadata concerning the playing of a digital content is changed by the other recording/playing device 702, and when the changed metadata is transmitted through the network 701. Although not particularly illustrated, identification data that identifies a digital content to be a subject of playing is combined in the transmitted metadata.

Similarly, an operation of the remote 600 is performed when the metadata concerning the playing of a digital content is changed by the other recording/playing device 702, and when the changed metadata is transmitted through the network 701. Identification data that identifies a digital content to be a subject of playing is combined in the transmitted metadata.

Explanation and illustration of a procedure of a processing by the recording/playing device 500 and a procedure of a processing by the remote 600 are omitted in the first example as being similar to the procedures explained in each of the embodiments described above.

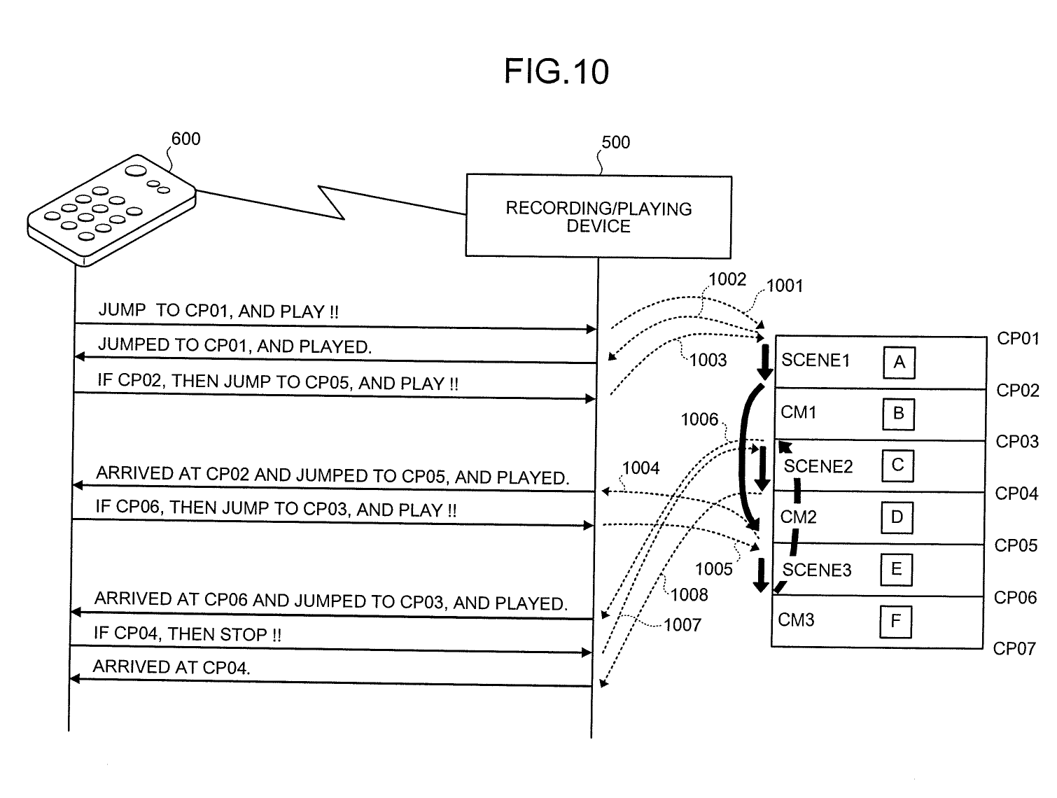

FIG. 10 is an explanatory diagram illustrating a sequence in interactive communication that is carried out between the recording/playing device 500 and the remote 600. Commands that are output from the remote 600 to the recording/playing device 500 and response data that is output from the recording/playing device 500 to the remote 600 are shown in a time series in FIG. 10. Digital content that is the subject of a play instruction by the remote 600 is shown in FIG. 10. The digital content in the recording/playing device 500 is the same digital content as the original digital content in the recording/playing device 702.

Among a group of arrows 1001 to 1008 shown in the center of FIG. 10, the arrows 1001, 1003, 1005, and 1007 pointing toward the right side from the left side indicate correspondence between commands that are output to the recording/playing device 500 from the remote 600 and top of data to be played by the recording/playing device 500 according to the commands. Among the group of arrows 1001 to 1008 shown in the center of FIG. 10, the arrows 1002, 1004, 1006, and 1008 pointing toward the left side from the right side indicate correspondence between response data that are output to the remote 600 from the recording/playing device 500 in reply to the commands that are output to the recording/playing device 500 from the remote 600 and output timing of the response data.

The sequence shown in FIG. 10 is started when metadata is output from the remote 600 to the recording/playing device 500 as a result of a process performed by the remote 600. When the metadata is output from the remote 600 to the recording/playing device 500, in the recording/playing device 500, the playing of a digital content is started in accordance with the metadata output from the remote 600. In FIG. 10, a case where the digital content is played in accordance with the metadata based on the newly created (changed) play list 901 (see FIG. 9) is described. At the playing of a digital content, it is preconditioned that the recording/playing device 500 is in a state in which the playing of a digital content as a subject of playing is enabled.

The state in which the playing of a digital content is enabled in the recording/playing device 500 is, for example, a state in which a digital content is stored in the HD 504. For example, when a digital content recorded on a recording medium such as a DVD is a subject of playing, a state in which the digital content recorded on the recording medium such as a DVD is readable can be regarded as the state in which the playing of a digital content is enabled. In the latter case, for example, when a DVD is used as the recording medium, the recording/playing device 500 is provided with a DVD drive that can read a digital content recorded on the DVD.

First, a command indicating “jump to chapter 01, and start playing data, top of which is identified by chapter 01” is output from the remote 600 to the recording/playing device 500 (refer to the arrow 1001 and “jump to CP01, and play!!” in FIG. 10). In response to the command, in the recording/playing device 500, the playing of the scene data 804, top of which is identified by chapter 01 is started. Furthermore, response data indicating “jumped to chapter 01 and started playing” is output from the recording/playing device 500 to the remote 600 (refer to the arrow 1002 and “jumped to CP01, and played” in FIG. 10).

Subsequently, a command indicating “upon reaching chapter 02, jump to chapter 05, and start playing data, top of which is identified by chapter 05” is output from the remote 600 to the recording/playing device 500 (refer to the arrow 1003 and “if CP02, then jump to CP05, and play!!” in FIG. 10).

In response to this command, in the recording/playing device 500, when the playing of the scene data 804 is finished, the playing of the scene data 806, top of which is identified by chapter 05 is started. Furthermore, response data indicating “reached chapter 02, jumped to chapter 05, and started playing” is output from the recording/playing device 500 to the remote 600 (refer to the arrow 1004 and “arrived at CP02 and jumped to CP05, and played” in FIG. 10).

Upon receipt of the response data indicating “jumped to chapter 05 and started playing” by the remote 600, a command indicating “upon reaching chapter 06, jump to chapter 03, and start playing data, top of which is identified by chapter 03” is output from the remote 600 to recording/playing device 500 (refer to the arrow 1005 and “if CP06, then jump to CP03, and play!!” in FIG. 10).

In response to this command, in the recording/playing device 500, when the playing of the scene data 806 is finished, the playing of the scene data 805, top of which is identified by chapter 05 is started. Furthermore, response data indicating “reached chapter 06, jumped to chapter 03, and started playing” is output from the recording/playing device 500 to the remote 600 (refer to the arrow 1006 and “arrived at CP06 and jumped to CP03, and played” in FIG. 10).

When the remote 600 receives the response data indicating “jumped to chapter 03 and started playing”, a command indicating “when chapter 04 is reached, stop playing” is output from the remote 600 to the recording/playing device 500 (refer to the arrow 1007 and “if CP04, then stop!!” in FIG. 10).

In response to this command, in the recording/playing device 500, when the playing of the scene data 805 is finished, response data indicating “reached chapter 04” is output from the recording/playing device 500 to the remote 600 (refer to the arrow 1008 and “arrived at CP04” in FIG. 10).

As described, with respect to a command that is output from the remote 600 to the recording/playing device 500, response data indicating that the command is executed in the recording/playing device 500 is output from the recording/playing device 500 to the remote 600. Therefore, in the remote 600, it is possible to check the progress of the playing operation by the recording/playing device 500. This enables to improve accuracy of the playing operation by the recording/playing device 500.

As described above, according to the recording/playing device 500 and the remote 600 of the first example, even when a description format of metadata that is edited by the other recording/playing device 702 differs from a description format of metadata in the recording/playing device 500, the description format of the metadata is converted by the remote 600. Therefore, it is possible to play a digital content according to an audiovisual condition set by the metadata that is edited by the other recording/playing device 702, in other words, to use the play-order sharing function.

With this arrangement, it is possible to use the play-order sharing function independent of the description format of the metadata that is acquired through the network 701 or the description format of the metadata in the recording/playing device 500. Therefore, an audiovisual form with higher flexibility can be provided.

Moreover, by acquiring metadata that is transmitted through the network 701 by the remote 600, even when the recording/playing device 500 is not connected (or cannot be connected) to the network 701, the play-order sharing function can be used.

Settings defined by metadata are not limited to that concerning the playing of a digital content. For example, it can be metadata concerning the recording of a digital content. Specifically, for example, the broadcast date, the broadcast channel, the broadcast time of a program desired to be recorded can be defined by the metadata. This enables a recording setting made in either of the recording/playing device 500 that is connected to the network 701 to be shared with the other recording/playing device 702.

More specifically, for example, the recording setting that is made outside can also be set in the recording/playing device 500 at home. Conversely, the recording setting is made at home and the same recording setting can be made in the recording/playing device 702 that is placed away from home. This enables, for example, to make a recording setting by families living away for an elderly person who is not sure about the operation of the recording/playing device 702.

In the first example, metadata is transmitted using an infrared ray from the remote 600 to the recording/playing device 500, however, it is not limited thereto. Instead of the transmission of the metadata by an infrared ray, for example, metadata can be transmitted by sound. In this case, a sound I/F and a speaker (both not shown) are provided in the remote 600. The recording/playing device 500 connects a microphone (not shown) to the sound I/F 510. Specifically, the microphone is connected to an A/D converter of the sound I/F 510. This enables to convert an analog sound signal into a digital signal.

Instead of the transmission by an infrared ray, for example, metadata can be transmitted by an image. The image to transmit metadata can be an image that expresses a facial expression of a person, or an image that expresses a gesture. In this case, an image I/F and a display (both not shown) are provided in the remote 600. In the ROM 602 provided in the remote 600, a program that converts metadata that is acquired through the network 701 into predetermined image data is stored. With this arrangement, metadata can be transmitted in a form of image by executing the program stored in the ROM 602 by the CPU 601.

Furthermore, when metadata is transmitted by an image, in the recording/playing device 500, a camera (not shown) is connected to the image I/F 509, the input I/F 508, or the like. In the ROM 502 provided in the recording/playing device 500, a program to analyze the image and to create a command based on the result of analysis is stored. By executing the program stored in the ROM 502 by the CPU 501, transmission of metadata by an image is enabled. A technique to analyze an image and a technique to create a command based on the result of analysis can be realized using a conventional program creating technology, and therefore, the explanation thereof is omitted.

Instead of the transmission by an infrared ray, metadata can be transmitted by a mechanical switching operation. Specifically, for example, when the recording/playing device 500 has the operation key 507 that is operated by physical pressing, a special device that includes pins that selectively appear in such a manner that the operation key 507 can be pressed can be provided, and metadata can be transmitted by causing the pins to appear corresponding to the metadata.

In the first example, the data relay device according to the present invention is implemented by a remote, however, it is not limited thereto. The data relay device according to the present invention can be implemented by a mobile terminal device that is provided separately from the digital-content playing device, such as a mobile telephone and a PDA.

### SECOND EXAMPLE

### Hardware Configuration of Mobile Telephone

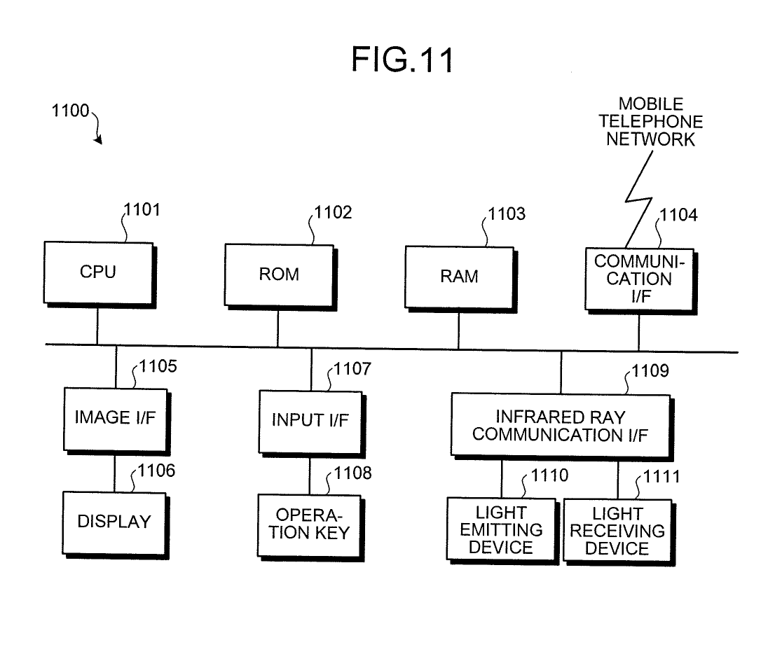

Next, a hardware configuration of a mobile telephone according to a second example of the present invention is explained. FIG. 11 is a block diagram of the hardware configuration of the mobile telephone according to the second example of the present invention. In the second example, use in a network environment using a mobile telephone 1100 is assumed instead of the remote 600 in the network environment shown in FIG. 7. Therefore, in the second example, the data relay device according to the present invention is implemented by the mobile telephone 1100. Moreover, in the second example, a mobile terminal device is implemented by the mobile telephone 1100.

The mobile telephone 1100 includes a PHS (personal handyphone system) terminal. In the second example, the data relay device according to the present invention is implemented by the mobile telephone 1100. In the second example, the explanation and the illustration of parts same as those explained in the first example are omitted. Hereafter, the same is applied.

The mobile telephone 1100 includes a CPU 1101, a ROM 1102, a RAM 1103, a communication I/F 1104, an image I/F 1105, a display 1106, an input I/F 1107, an operation key 1108, an infrared ray communication I/F 1109, a light emitting device 1110, and a light receiving device 1111. An external appearance and the like of the mobile telephone are the same as conventional ones, and therefore, the explanation thereof is omitted.

The CPU 1101 centrally controls respective parts in the mobile telephone 1100. The ROM 1102 stores fixed data such as a control program to operate the CPU 1101 in advance. The RAM 1103 rewritably stores various kinds of data and functions as a work area of the CPU 1101. The RAM 1103 can be a flash memory or the like that stores data in a nonvolatile manner independent of turning on/off of the power of the mobile telephone 1100.

The communication I/F 1104 is connected to a mobile telephone network. Although explanation is omitted since it is a conventional technology, the mobile communication network constitutes a part of the Internet. Therefore, the mobile telephone 1100 is connected to the Internet through the communication I/F 1104. The communication I/F 1104 is controlled by the CPU 1101, and performs communication of various kinds of data including metadata with a communication I/F provided in another mobile telephone or with a server that is connected to the mobile telephone network (both not shown) by downloading, streaming, mail transmission, or the like. Although explanation is omitted since it is a conventional technology, the mobile telephone 1100 has a special function, such as a browsing function, for an operation with respect to the Internet.

In the second example, the mobile telephone 1100 having an infrared ray communication function is used as the data relay device, however, it is not limited thereto. Instead of the mobile telephone 1100 having the infrared ray communication function, various kinds of mobile terminal devices having an infrared communication function can be used.

As described above, according to the second example, the mobile telephone 1100 that is widely used is employed as the data relay device, thereby enabling to implement the various functions described above using a mobile terminal device that has already been obtained, without using a new device particularly prepared.

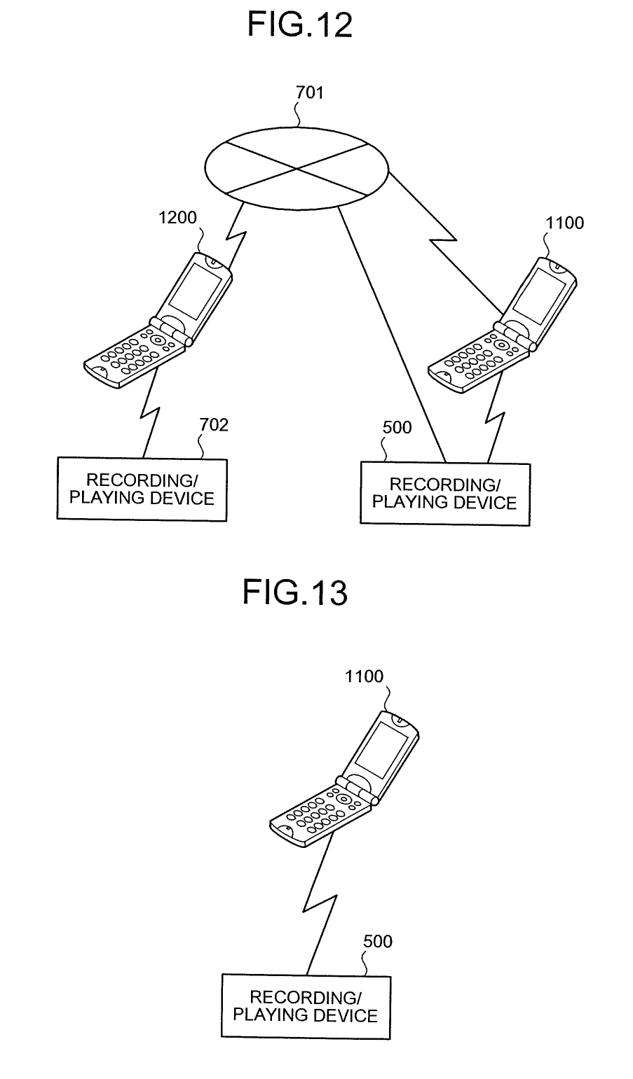

FIG. 12 is a block diagram illustrating one example of a network environment assuming use of a recording/playing device and a mobile telephone according to another example of the present invention. In the second example, metadata that is edited by the recording/playing device 702 is directly output to the network 701 from the recording/playing device 702, however, it is not limited thereto. As shown in FIG. 12, the metadata that is edited by the recording/playing device 702 can be transmitted to the network 701 from the recording/playing device 702 through a mobile telephone 1200. In this case, the mobile telephone 1200 is associated with the recording/playing device 702 that edits metadata. Since a configuration of the mobile telephone 1200 is the same as that of the mobile telephone 1100, the explanation thereof is omitted.

Although an illustration is omitted, configuration can be to obtain, by the remote 600, metadata that is output through the mobile telephone 1200 to the network 701. Similarly, an illustration is omitted, but as another example of the present invention, configuration can be to output metadata that is edited by the recording/playing device 702 to the network 701 through a remote (not shown), and obtained through the remote 600. In other words, transmission (output) of metadata, whose subject of playing is a digital content to be played by the recording/playing device 500, to the network 701 can be performed directly by the recording/playing device 702, or can be performed indirectly through the remote, the mobile telephone 1200, or the like.

### THIRD EXAMPLE

FIG. 13 is a block diagram illustrating a network environment assuming use of a recording/playing device and a remote according to a third example of the present invention. The recording/playing device 500 according to the third example outputs, in addition to metadata, a compressed digital content that is obtained by compressing a digital content associated with this metadata to the mobile telephone 1100 that is associated therewith in advance. The compressed digital content is obtained by compressing a digital content being a subject of playing of metadata to data that can be played by the corresponding mobile telephone 1100. As a compression technique of a digital content, various kinds of conventional digital data compression techniques can be applied.

The mobile telephone 1100 receives metadata and a compressed digital content that are output from the recording/playing device 500 that has been associated therewith in advance. In the mobile telephone 1100, the acquired metadata can be newly created (changed) based on an operation of the operation key 1108 by a user. A method of newly creating (changing) metadata is the same as the method of newly creating (changing) metadata in the recording/playing device 702.

At newly creating (changing) metadata, configuration can be to play the received compressed digital content based on an operation of the operation key 1108 by a user. Thus, the metadata can be newly created (changed) while viewing the digital content on the display 1106 of the mobile telephone 1100. Moreover, after the metadata and the compressed digital content are received from the recording/playing device 500, the operation to newly create (change) the metadata can be performed away from the recording/playing device 500.

The newly created (changed) metadata can be output at the time of playing of the digital content based on an operation of the operation key 1108 by a user.

In the third example, a compressed digital content is output to the mobile telephone 1100, however, it is not limited thereto. To the mobile telephone 1100, a digital content that is not compressed can be output together with metadata concerning the digital content.

The data relay method and the digital content playing method explained in the examples described above can be implemented by a computer such as a personal computer and a workstation executing a program that is prepared in advance. The program is recorded on a computer-readable recording medium such as a CD-ROM, an MO, and a DVD, and is executed by being read out from the recording medium by a computer. Furthermore, the program can be a transmission medium that can be distributed through a network such as the Internet.

1-11. (canceled)

12. A data relay device constituted of a mobile terminal provided as a separate entity from an associated digital-content playing device, the data relay device comprising:
an acquiring unit that acquires metadata of a digital content through a network, the metadata being related to a playing of the digital content on a digital-content playing device;
a converting unit that converts a description format of the acquired metadata into a compatible description format that enables the playing of the digital content on the associated digital-content playing device; and
a communicating unit that outputs the converted metadata to the associated digital-content playing device.

13. The data relay device according to claim 12, further comprising a determining unit that determines whether the description format of the acquired metadata is the compatible description format, wherein
the converting unit converts the description format of the acquired metadata when the determining unit determines the description format as not the compatible description format.

14. The data relay device according to claim 12, wherein the communicating unit includes an interface with the associated digital-content playing device, and outputs the converted metadata through the interface.

15. The data relay device according to claim 12, wherein the data relay device is applicable to a plurality of associated digital-content playing devices.

16. A digital-content playing device that is provided as a separate entity from a data relay device constituted of a mobile terminal that acquires metadata from a network and converts a description format of the metadata into a description format compatible with the digital-content playing device prior to outputting the metadata, the digital-content playing device comprising:
a first acquiring unit that acquires, from the network through a route different from that of the data relay device, a first metadata of a digital content, the first metadata being related to a playing of the digital content;
a second acquiring unit that acquires a second metadata output from the data relay device, the second metadata having a compatible description format that enables the playing of the digital content on the digital-content playing device; and
a playing unit that plays the digital content based on any one of the first metadata and the second metadata.

17. The digital-content playing device according to claim 16, further comprising a determining unit that determines whether a description format of the first metadata is the compatible description format, wherein
the playing unit plays the digital content based on the second metadata when the determining unit determines the description format of the first metadata as not the compatible description format.

18. A data relay method of a data relay device constituted of a mobile terminal provided as a separate entity from an associated digital-content playing device, the data relay method comprising:
acquiring metadata of a digital content through a network, the metadata being related to a playing of the digital content on a digital-content playing device;
converting a description format of the acquired metadata into a compatible description format that enables the playing of the digital content on the associated digital-content playing device; and
outputting the converted metadata to the associated digital-content playing device.

19. The data relay method according to claim 18, further comprising determining whether the description format of the acquired metadata is the compatible description format, wherein
the converting includes converting the description format of the acquired metadata when, at the determining, the description format is determined as not the compatible description format.

20. The data relay method according to claim 18, wherein the outputting includes outputting the converted metadata through an interface with the associated digital-content playing device.

21. The data relay method according to claim 18, wherein the data relay device is applicable to a plurality of associated digital-content playing devices.

22. A digital-content playing method of a digital-content playing device that is provided as a separate entity from a data relay device constituted of a mobile terminal that acquires metadata from a network and converts a description format of the metadata into a description format compatible with the digital-content playing device prior to outputting the metadata, the digital-content playing method comprising:
acquiring, from the network through a route different from that of the data relay device, a first metadata of a digital content, the first metadata being related to a playing of the digital content;
acquiring a second metadata that is output from the data relay device, the second metadata having a compatible description format that enables the playing of the digital content on the digital-content playing device; and
playing the digital content based on any one of the first metadata and the second metadata.

23. The digital-content playing method according to claim 22, further comprising determining whether a description format of the first metadata is the compatible description format, wherein
the playing includes playing the digital content based on the second metadata when, at the determining, the description format of the first metadata is determined as not the compatible description format.

24. A computer readable recording medium storing therein a data relay program that is related to a data relay device that is constituted of a mobile terminal provided as a separate entity from an associated digital-content playing device and that causes a computer to execute:
acquiring metadata of a digital content through a network, the metadata being related to a playing of the digital content on a digital-content playing device;
converting a description format of the acquired metadata into a compatible description format that enables the playing of the digital content on the associated digital-content playing device; and
outputting the converted metadata to the associated digital-content playing device.

25. The computer-readable recording medium according to claim 24, wherein the data relay program further causes the computer to execute determining whether the description format of the acquired metadata is the compatible description format, wherein
the converting includes converting the description format of the acquired metadata when, at the determining, the description format is determined as not the compatible description format.

26. The computer-readable recording medium according to claim 24, wherein the outputting includes outputting the converted metadata through an interface with the associated digital-content playing device.

27. The computer-readable recording medium according to claim 24, wherein the data relay device is applicable to a plurality of associated digital-content playing devices.

28. A computer readable recording medium storing therein a digital-content playing program that is related to a digital-content playing device provided as a separate entity from a data relay device constituted of a mobile terminal that acquires metadata from a network and converts a description format of the metadata into a description format compatible with the digital-content playing device prior to outputting the metadata, the computer readable recording medium storing the digital-content playing program that causes a computer to execute:
acquiring, from the network through a route different from that of the data relay device, a first metadata of a digital content, the first metadata being related to a playing of the digital content;
acquiring a second metadata that is output from the data relay device, the second metadata having a compatible description format that enables the playing of the digital content on the digital-content playing device; and
playing the digital content based on any one of the first metadata and the second metadata.

29. The computer-readable recording medium according to claim 28, wherein the digital-content playing program further causes the computer to execute determining whether a description format of the first metadata is the compatible description format, wherein
the playing includes playing the digital content based on the second metadata when, at the determining, the description format of the first metadata is determined as not the compatible description format.
